(19) United States
(12) Patent Application Publication
(10) Pub. No.: US 2013/0085850 A1
(43) Pub. Date: Apr. 4, 2013

(54) LOCATION-BASED ADVERTISING FOR ROVING SERVICE PROVIDERS

(71) Applicant: KENSHOO, LTD., Tel-Aviv (IL)

(72) Inventors: EREZ SHASHA, KIRYAT ONO (IL); TAL HASHAI, TEL-AVIV (IL); NIR COHEN, RISHON LETZION (IL)

(73) Assignee: KENSHOO, LTD., TEL-AVIV (IL)

(21) Appl. No.: 13/633,923

(22) Filed: Oct. 3, 2012

Related U.S. Application Data
(60) Provisional application No. 61/542,317, filed on Oct. 3, 2011.

(51) Int. Cl. G06Q 30/02

(52) U.S. Cl. CPC G06Q 30/0251
USPC 705/14.49

(57) ABSTRACT

Facilitating the provision of advertising by receiving a notification indicating a location of a roving provider of a service, and updating data associated with the roving provider based on the location of the roving provider, where a computer server is configured to provide, responsive to a search of the data, advertising that is associated with the roving provider, and where the search is associated with both the service and the location.

### CROSS-REFERENCE TO RELATED APPLICATIONS

This application claims priority from U.S. Provisional Patent Application No. 61/542,317, filed Oct. 3, 2011, which is incorporated herein by reference in its entirety.

### FIELD OF THE INVENTION

The present invention relates to computer-based advertising in general.

### BACKGROUND OF THE INVENTION

Computer-network based advertising servers and search engines are often configured to provide computer-network based advertising in response to queries. For example, a search engine that receives a query that includes the words “hardware store” may provide advertising related to hardware stores. More sophisticated advertising servers and search engines may recognize that the query originated from a specific geographical location and provide advertising related to hardware stores that are located in the same geographical location.

### SUMMARY OF THE INVENTION

In one aspect of the invention a method is provided for facilitating the provision of advertising, the method including receiving a notification indicating a location of a roving provider of a service, and updating data associated with the roving provider based on the location of the roving provider, where a computer server is configured to provide, responsive to a search of the data, advertising that is associated with the roving provider, and where the search is associated with both the service and the location.

In another aspect of the invention the updating step includes updating the data to include a keyword associated with the location of the roving provider.

In another aspect of the invention the updating step includes causing the computer server to update the data.

In another aspect of the invention the location is a current location of the roving provider.

In another aspect of the invention the location is a future location of the roving provider.

In another aspect of the invention the service includes providing a product.

In another aspect of the invention the advertising includes a network address of a web page that is associated with the roving provider.

In another aspect of the invention the method further includes performing the receiving and updating steps a plurality of times for a corresponding plurality of different locations of the roving provider, where during any of the updating steps the data are updated to remove therefrom previous location information associated with the roving provider.

In another aspect of the invention the receiving step includes receiving the notification from a device where the notification is sent from the device without active intervention by the roving provider.

In another aspect of the invention the receiving step includes receiving the notification from a device where the notification is sent from the device as a direct result of the roving provider controlling the device to send the notification.

In another aspect of the invention a system is provided for facilitating the provision of advertising, the system including a data storage device configured to store data associated with a roving provider of a service, and a computer server configured to receive a notification indicating a location of the roving provider, update the data associated with the roving provider based on the location of the roving provider, and provide, responsive to a search of the data, advertising that is associated with the roving provider, where the search is associated with both the service and the location.

In another aspect of the invention the computer server is configured to update the data to include a keyword associated with the location of the roving provider.

In another aspect of the invention the location is a current location of the roving provider.

In another aspect of the invention the location is a future location of the roving provider.

In another aspect of the invention the service includes providing a product.

In another aspect of the invention the advertising includes a network address of a web page that is associated with the roving provider.

In another aspect of the invention the system further includes performing the receiving and updating steps a plurality of times for a corresponding plurality of different locations of the roving provider, where during any of the updating steps the data are updated to remove therefrom previous location information associated with the roving provider.

In another aspect of the invention the notification is sent from a device without active intervention by the roving provider.

In another aspect of the invention the notification is sent from a device as a direct result of the roving provider controlling the device to send the notification.

In another aspect of the invention a computer program product is provided for facilitating the provision of advertising, the computer program product including a computer-readable storage medium, and computer-readable program code embodied in the computer-readable storage medium, where the computer-readable program code is configured to receive a notification indicating a location of a roving provider of a service, and update data associated with the roving provider based on the location of the roving provider, where a computer server is configured to provide, responsive to a search of the data, advertising that is associated with the roving provider, and where the search is associated with both the service and the location.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for facilitating the provision of advertising, constructed and operative in accordance with an embodiment of the invention; and

FIG. 2 is a simplified flowchart illustration of an exemplary method of operation of the system of FIG. 1, operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

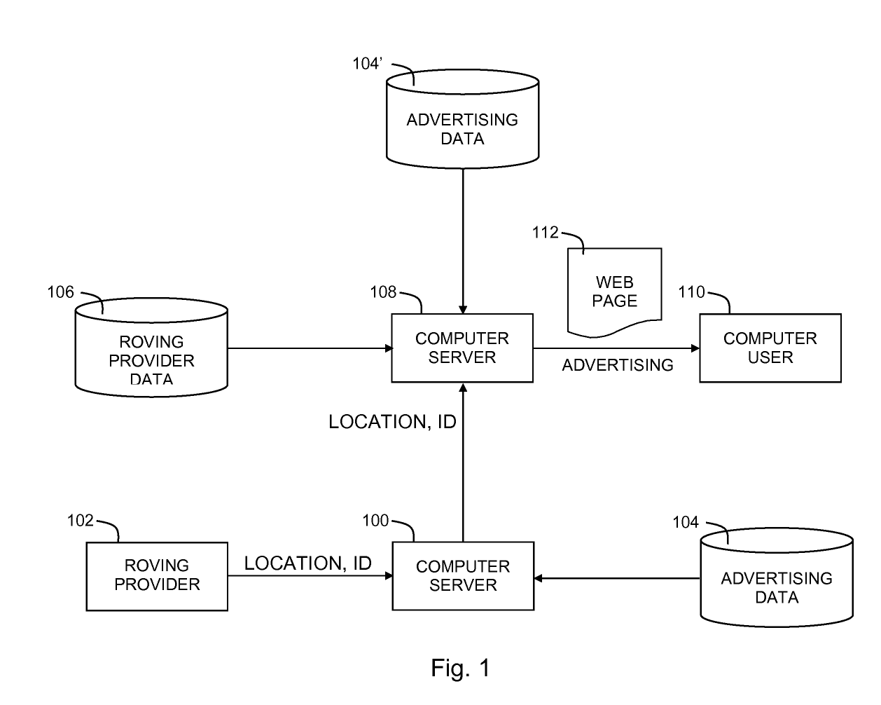

Reference is now made to FIG. 1, which is a simplified conceptual illustration of a system for facilitating the provision of advertising, constructed and operative in accordance with an embodiment of the invention. In the system of FIG. 1 a computer server 100 is configured to receive notifications, such as via a computer network or telecommunications network (not shown), indicating the location of a roving provider 102 of a service, where the service may include providing a product. The location may be the current location of roving provider 102, or may be a location where roving provider 102 is expected to be in the future, such as a destination of roving provider 102 to which roving provider 102 is currently, or will be, in transit. The notifications may be actively or passively provided by roving provider 102 or an agent thereof using known means, such as using a GPS-capable device, which may be a mobile telephone or other tracking device, that is conveyed by or with roving provider 102. The notifications may be provided directly to computer server 100, or indirectly via one or more intermediate agents, such as where the notifications are sent to a social networking website that is associated with roving provider 102. The notifications are preferably provided together with an identifier that identifies roving provider 102. Computer server 100 preferably maintains advertising data 104 that are associated with roving provider 102. Advertising data 104 may include, in association with roving provider 102, any data that are known in connection with computer-network based advertising, such as advertisements, keywords associated with the advertisements, bid policy information, and platform-specific information, such as relating to Google AdGroups™ or Facebook Sponsored Ads™.

Computer server 100 is also configured to update roving provider data 106, that are associated with roving provider 102, based on the location of roving provider 102 as received in the notification. Roving provider data 106 may be maintained at a computer server 108, and may include location data associated with roving provider 102, as well as information regarding the service(s) provided by roving provider 102, which information may, for example, be in the form of keywords. Computer server 100 provides to computer server 108 the location of roving provider 102 as received in the notification, together with the aforementioned identifier(s). Computer server 108 preferably updates roving provider data 106 with the location of roving provider 102 as received in the notification. Roving provider data 106 may be updated to include any of the following based on the different locations of roving provider 102:
one or more keywords associated with the location of roving provider 102, such as a city name and/or a street address associated with the location,
one or more keywords associated with roving provider 102 and/or the service provided by roving provider 102,
advertising and/or advertising components, such as wording or associated hypertext links as described hereinbelow,
bid information associated with any of the above, where any of the above are provided by computer server 100 to computer server 108, by computer server 108 itself, or both.

Computer server 108 is preferably configured to provide, in response to a search of roving provider data 106, advertising that is associated with roving provider 102, such as where computer server 108 is a search engine or social network server that has access to such advertising, such as by operating as, or by accessing, an advertising network (not shown), or where computer server 108 is an advertising server where such advertising is maintained in advertising data 104′ which may include information such as is described with reference to advertising data 104. The search is preferably associated with both a service and a location, such as where the search is performed in response to a query made by a computer user 110 that includes one or more keywords describing the service, and where the location of computer user 110 is known to computer server 108. In response to a search for service X and location Y, computer server 108 preferably provides advertising associated with roving provider 102, where roving provider 102 provides service X and is associated with location Y. The advertising provided by computer server 108, such as to computer user 110, preferably includes a network address of a web page 112 that is associated with roving provider 102. For example, computer server 108 may provide the advertising in the form of a graphical advertisement within a web page that is provided to computer user 110, where the graphical advertisement includes, in the form of a hypertext link, the network address of a “landing” web page that is associated with roving provider 102. Computer user 110 may then act upon the received advertising in any known manner, and the behavior of computer user 110 in connection with the received advertising, such as interacting with received advertising (e.g., “clicking”) or purchasing an advertised product or service, may be monitored in any known manner.

Computer servers 100 and 108 are preferably configured to operate as described above for multiple notifications relating to corresponding multiple different locations of roving provider 102. Preferably, whenever roving provider data 106 are updated to include the location of roving provider 102 as indicated in a currently-received notification, any previous location information associated with roving provider 102 are removed from roving provider data 106.

In an alternative embodiment, the functionality of computer servers 100 and 108 as described hereinabove may be embodied in a single computer server.

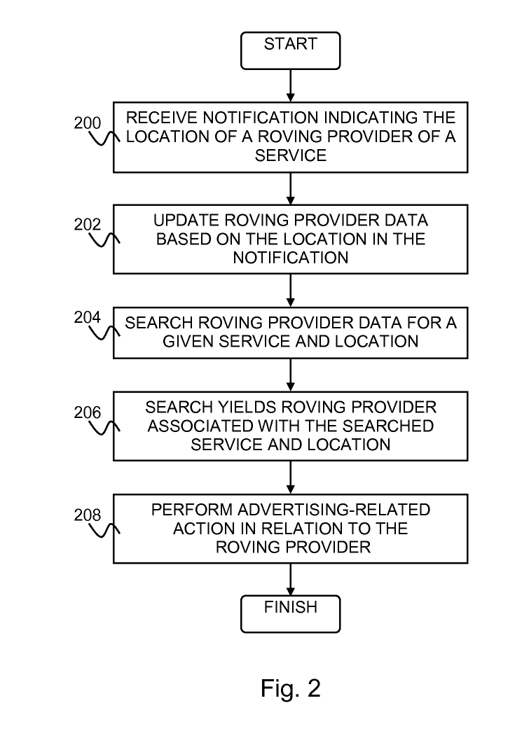

Reference is now made to FIG. 2, which is a simplified flowchart illustration of an exemplary method of operation of the system of FIG. 1, operative in accordance with an embodiment of the invention. In the method of FIG. 2, a notification is received indicating the location of a roving provider of a service (step 200), where the service may include providing a product, and where the location may be the current location of the roving provider or a location where the roving provider is expected to be in the future. The notification is preferably provided together with an identifier that identifies the roving provider. Roving provider data that are associated with the roving provider are updated based on the location of the roving provider as received in the notification (step 202). A search of the roving provider data is performed (step 204), where the search is associated with a service and location. If the search yields a roving provider that provides the service and that is associated with the location (step 206), an advertising-related action is performed in relation to the roving provider (step 208), such as by providing advertising associated with the roving provider to a computer user that initiated a query that triggered the search, or by promoting advertising associated with the roving provider, such as by changing bid information associated with such advertising.

The system of FIG. 1 and method of FIG. 2 may be illustrated by way of the following examples. In one example, a plumber provides periodic notifications of his current location throughout his workday to computer server 100, which maintains information regarding the plumber's advertising campaign on computer server 108. The notifications are provided periodically by an app on the plumber's GPS-enabled mobile telephone and without active intervention by the plumber. Computer server 100 notifies computer server 108 of the plumber's current location, where computer server 108 maintains the plumber's service and location information in a database, which may include roving provider data 106. At approximately the same time as computer server 100 notifies computer server 108 of the plumber's current location, or within a predefined time thereafter, computer 108 receives a browser-based query from computer user 110, who is located at or near the plumber's current location, the with the keyword “plumber”. Computer 108 searches its database using the query parameters, including the keyword “plumber” and the location of computer user 110, and identifies the plumber as meeting these parameters, where the searched location matches the plumber's current location within a predefined match tolerance. Computer 108 then provides to computer user 110, in a web page response, advertising that is associated with the plumber.

In another example, a taxi driver enters her next destination into an app on a computer-network-capable device, which then sends a notification of the taxi driver's destination to computer server 100 which then informs computer server 108 of the taxi driver's future location at a given exact or estimated time. Computer server 108 then provides advertising as described above in response to a search of its database of roving service providers for a taxi driver who will be at the indicated location at the given time.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for facilitating the provision of advertising, the method comprising:
receiving a notification indicating a location of a roving provider of a service; and
updating data associated with the roving provider based on the location of the roving provider,
wherein a computer server is configured to provide, responsive to a search of the data, advertising that is associated with the roving provider, and
wherein the search is associated with both the service and the location.

2. The method according to claim 1 wherein the updating step comprises updating the data to include a keyword associated with the location of the roving provider.

3. The method according to claim 1 wherein the updating step comprises causing the computer server to update the data.

4. The method according to claim 1 wherein the location is a current location of the roving provider.

5. The method according to claim 1 wherein the location is a future location of the roving provider.

6. The method according to claim 1 wherein the service includes providing a product.

7. The method according to claim 1 wherein the advertising includes a network address of a web page that is associated with the roving provider.

8. The method according to claim 1 and further comprising performing the receiving and updating steps a plurality of times for a corresponding plurality of different locations of the roving provider, wherein during any of the updating steps the data are updated to remove therefrom previous location information associated with the roving provider.

9. The method according to claim 1 wherein the receiving step comprises receiving the notification from a device where the notification is sent from the device without active intervention by the roving provider.

10. The method according to claim 1 wherein the receiving step comprises receiving the notification from a device where the notification is sent from the device as a direct result of the roving provider controlling the device to send the notification.

11. A system for facilitating the provision of advertising, the system comprising:
a data storage device configured to store data associated with a roving provider of a service; and
a computer server configured to
receive a notification indicating a location of the roving provider,
update the data associated with the roving provider based on the location of the roving provider, and
provide, responsive to a search of the data, advertising that is associated with the roving provider,
wherein the search is associated with both the service and the location.

12. The system according to claim 11 wherein the computer server is configured to update the data to include a keyword associated with the location of the roving provider.

13. The system according to claim 11 wherein the location is a current location of the roving provider.

14. The system according to claim 11 wherein the location is a future location of the roving provider.

15. The system according to claim 11 wherein the service includes providing a product.

16. The system according to claim 11 wherein the advertising includes a network address of a web page that is associated with the roving provider.

17. The system according to claim 11 and further comprising performing the receiving and updating steps a plurality of times for a corresponding plurality of different locations of the roving provider, wherein during any of the updating steps the data are updated to remove therefrom previous location information associated with the roving provider.

18. The system according to claim 11 wherein the notification is sent from a device without active intervention by the roving provider.

19. The system according to claim 11 wherein the notification is sent from a device as a direct result of the roving provider controlling the device to send the notification.

20. A computer program product for facilitating the provision of advertising, the computer program product comprising:
a computer-readable storage medium; and
computer-readable program code embodied in the computer-readable storage medium, wherein the computer-readable program code is configured to
receive a notification indicating a location of a roving provider of a service, and
update data associated with the roving provider based on the location of the roving provider,
wherein a computer server is configured to provide, responsive to a search of the data, advertising that is associated with the roving provider, and
wherein the search is associated with both the service and the location.
